(19) United States
(12) Patent Application Publication
(10) Pub. No.: US 2021/0290479 A1
(43) Pub. Date: Sep. 23, 2021

(54) MASSAGER DEVICE

(71) Applicants: Dong-Her Wu, Puyen Hsiang (TW); IREST HEALTH SCIENCE AND TECHNOLOGY CO .,LTD, Jiaxing (CN)

(72) Inventor: Dong-Her Wu, Puyen Hsiang (TW)

(21) Appl. No.: 17/027,289

(22) Filed: Sep. 21, 2020

(30) Foreign Application Priority Data
Mar. 20, 2020 (TW) 109109711

(51) Int. Cl. A61H 15/00

(52) U.S. Cl. CPC A61H 15/0078; A61H 2201/1215; A61H 2201/1669; A61H 2015/0021

(57) ABSTRACT

A massage device has a transmission unit, a massaging member and a base. The transmission unit has a motor, at least one first link rod and at least one second link rod. At least one driving shaft is disposed on a side of the motor, and the first and second link rods both respectively have a first end and a second end. The transmission unit drives the first and second link rods through the motor, with the first and second link rods and the cooperation of the massaging member and the base, the first link rod acts as a swinging arm to make the second link rod to have rocking movements. So that the motor is able to continue to rotate forward to generate the reciprocating swing movements of the member and there is no need to install limit switches to control the forward and reverse rotation of the motor.

### BACKGROUND OF INVENTION

### Field of Invention

The present invention relates to a massage device, and more particularly to a massage device with a rotatable transmission unit.

### Description of Related Art

In modern life, people are under various stress and are easily suffer body aches. Therefore, various massage devices are employed to massage different parts of the body to ease the body tension. The general massage devices are divided into a body massage device such as a massage chair, a massage bed, etc., and a partial massage device such as a shoulder-neck massage belt, a waist massage belt or a calf and foot massage machine, etc. All of them employ rollers, airbags or vibration to generate mechanical press on corresponding body parts to relieve the tension of the muscles.

In particular, there are more and more people suffer soreness, tightness and water retention in their lower limbs. Therefore, lower limb massage mechanisms are developed to provide massage for lower limbs and feet. The lower limb massage device can be used alone or in combination with a massage chair. However, common lower limb massage mechanisms usually has a complicated massage mechanism which is requires too much space.

Therefore, it is desirable to provide a hose connecting device to mitigate and/or obviate the aforementioned problems.

### SUMMARY OF INVENTION

An objective of present invention is to provide a hose connecting device, which is capable of improving the above-mention problems.

In order to achieve the above mentioned objective, A massage device has a transmission unit, a massaging member and a base. The transmission unit has a motor, at least one first link rod and at least one second link rod. At least one driving shaft is disposed on a side of the motor, and the first and second link rods both respectively have a first end and a second end. The transmission unit drives the first and second link rods through the motor, with the first and second link rods and the cooperation of the massaging member and the base, the first link rod acts as a swinging arm to make the second link rod to have rocking movements. So that the motor is able to continue to rotate forward to generate the reciprocating swing movements of the member and there is no need to install limit switches to control the forward and reverse rotation of the motor.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment according to the present invention.

FIG. 2 is an exploded view of the preferred embodiment according to the present invention.

FIG. 3 is a top view of the preferred embodiment according to the present invention.

FIG. 4 is a schematic drawing of the continuous operation of the preferred embodiment according to the present invention.

FIG. 5 is another schematic drawing of the continuous operation of the preferred embodiment according to the present invention.

FIG. 6 is another schematic drawing of the continuous operation of the preferred embodiment according to the present invention.

FIG. 7 is another schematic drawing of the continuous operation of the preferred embodiment according to the present invention.

### DETAILED DESCRIPTION OF PREFERRED EMBODIMENT

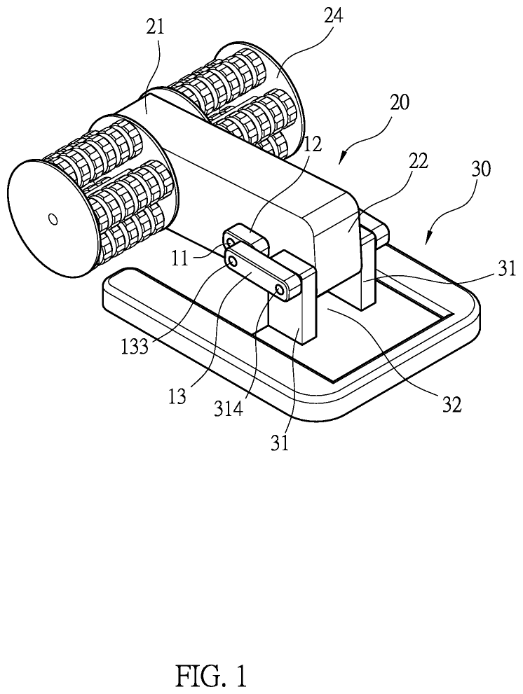

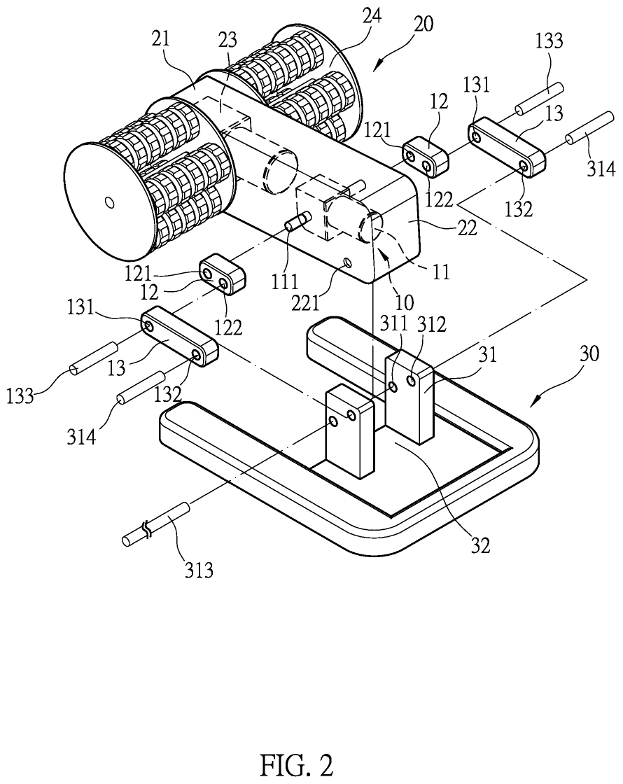

Please refer to FIG. 1 and FIG. 2. A massage device comprises: a transmission unit 10, a massaging member 20 and a base 30. The transmission unit 10 has a motor 11, at least one first link rod 12 and at least one second link rod 13. At least one driving shaft 111 is disposed on a side of the motor 11, and the first and second link rod 12, 13 both respectively have a first end 121, 131 and a second end 122, 132. The first end 121 of the first link rod 12 is pivoted with the driving shaft 111 of the motor 11, the second end 122 and the first end 131 of the second link rod 13 are pivoted together by a shaft rod 133, and the motor 11 drives the first and second link rod 12, 13 to rotate.

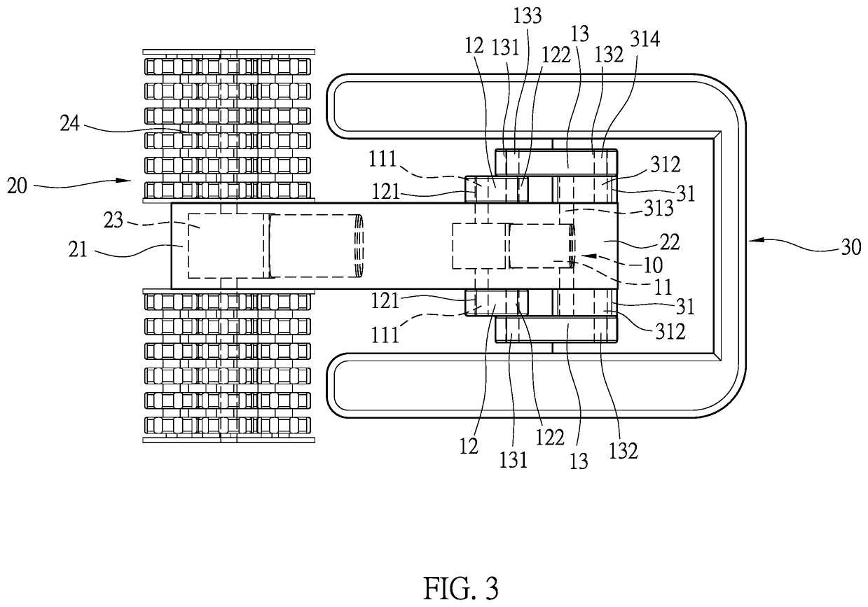

For the embodiment of the present invention, please refer to FIGS. 1, 2 and 3. A driving shaft 111 is mounted at each side of the motor 11 of the transmission unit 10 and connected to the two first link rods 12 and the two second link rods 13. The massaging member 20 has a massaging end 21 and a swinging end 22, and the massaging end 21 drives the two massaging unit 24 with another motor 23, the swinging end 22 is connected to the motor 11 of the transmission unit 10. The two driving shafts 111 respectively pass through the swinging end 22 and are respectively connected to each first end 121 of the first link rod 12, and the swinging end 22 has a through aperture 221 at an eccentric position. The base 30 has two parallel assembling portions 31 and an assembly space 32 between the assembling portions 31. Each assembling portion 31 has a shaft hole 311 and a securing hole 312, and a position of the securing hole 312 can higher or lower than the shaft hole 311. The assembly space 32 is configured for accepting the swinging end 22 of the massaging member 20, the shaft holes 311 of the two assembling portions 31 and the through aperture 221 of the swinging end 22 are both pivoted with the central shaft 313, and the securing holes 312 of the two assembling portions 31 are respectively pivoted with a shaft bolt 314 and the second end 132 of the second link rod 13. Therefore, the massaging member 20 is mounted onto the base 30, and the transmission unit 10 drives the massaging member 20 to rotate on the base 30.

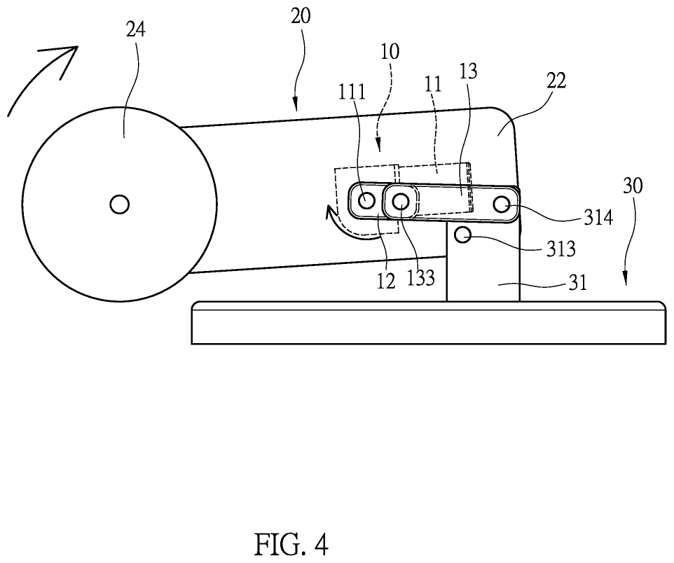

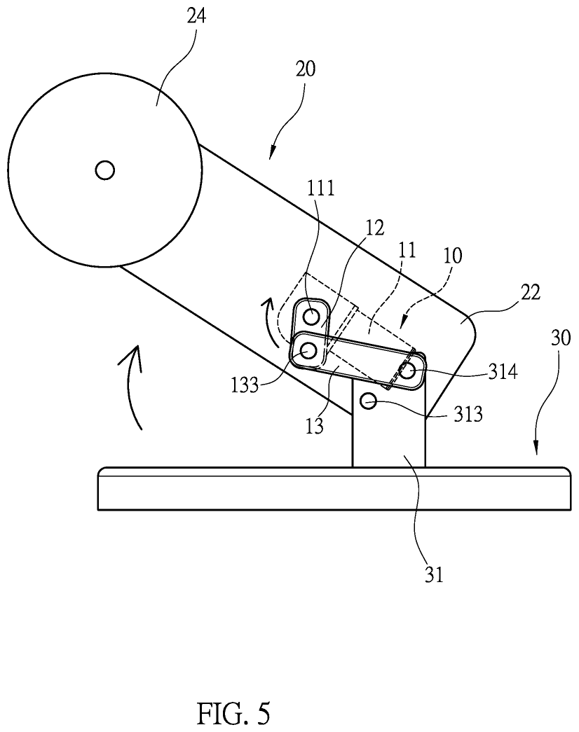

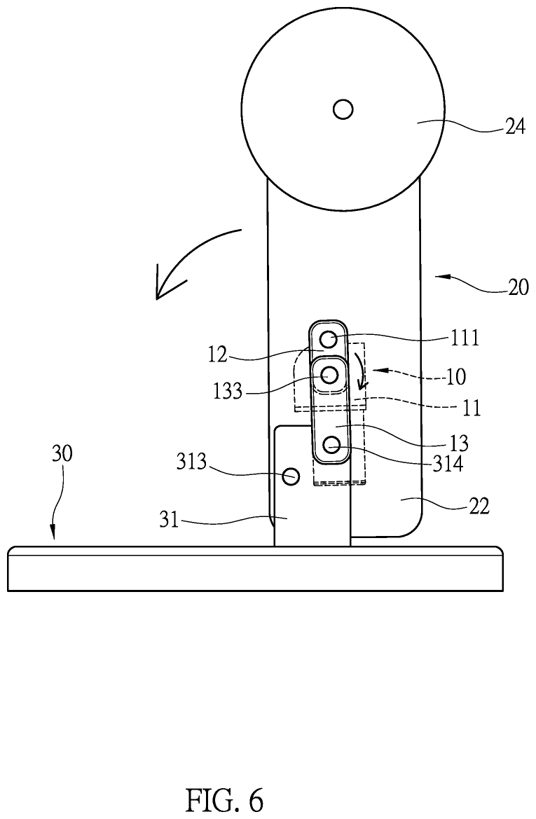

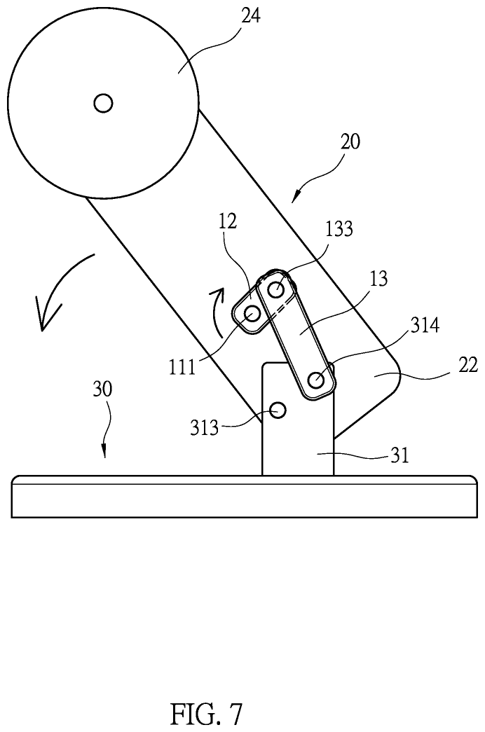

For actual operation, please refer to FIGS. 1, 3 and 4-7. The motor 11 of the transmission unit 10 drives the driving shaft 111 to rotate, and since the second end 132 of the second link rod 13 and the securing holes 312 of the assembling portions 31 are connected together, the first link rod 12 is driven by the driving shaft 111, the second link rod 13 acts as a swing arm and pushes the swinging end 22 of the massaging member 20 to rotate around the central shaft 313, and the massaging member 20 swings back and forth with the second link rod 13.

With the structure of the above specific embodiment, the following benefits can be obtained: the transmission unit 10 drives the first and second link rods 12, 13 through the motor 11, with the first and second link rods 12, 13 and the cooperation of the massaging member 20 and the base 30, the first link rod 12 acts as a swinging arm to make the second link rod 13 to have back and forth rocking movements. So that the motor 11 is able to continue to rotate forward to generate the reciprocating swing movements of the member 20 and there is no need to install limit switches to control the forward and reverse rotation of the motor, which not only reduce the structure assembly cost and improve the convenience of the structure assembly, but also avoid the motor 11 from damage.

Although the present invention has been explained in relation to its preferred embodiment, it is to be understood that many other possible modifications and variations can be made without departing from the spirit and scope of invention as hereinafter claimed.

What is claimed is:

1. A massage device comprising:
a transmission unit having a motor, at least one first link rod and at least one second link rod, at least one driving shaft disposed on a side of the motor, the first and second link rods both respectively having a first end and a second end, the first end of the first link rod pivoted onto the driving shaft of the motor, the second end of the first link rod connected to the first end of the second link rod;
a massaging member having a massaging end and a swinging end, the massaging end driving at least one massaging unit, the swinging end connected to the motor of the transmission unit, the driving shaft passing through the swinging end and connected to the first end of the first link rod, and the swinging end having a through aperture at an eccentric position; and
a base having at least one assembling portion with a shaft hole and a securing hole, both of the shaft hole and the through aperture of the swinging end pivoted with a central shaft, the securing hole and the second end of the second link rod bolted by a shaft bolt;
wherein the motor drives the driving shaft to rotate, and since the second end of the second link rod and the securing hole of the assembling portion are connected together, the first link rod is driven by the driving shaft, the second link rod acts as a swing arm and pushes the swinging end to rotate around the central shaft, and the massaging member swings back and forth.

2. The massage device as claimed in claim 1, wherein the motor of the transmission unit has a driving shaft at each side coaxial with the first link rod and the second link rod respectively, and the driving shafts of the motor drive the first link rod and the second link rod to rotate.

3. The massage device as claimed in claim 1, wherein a position of the securing hole of the assembling portion is higher than the shaft hole.

4. The massage device as claimed in claim 1, wherein a position of the securing hole of the assembling portion is lower than the shaft hole.

5. The massage device as claimed in claim 2, wherein the base has two parallel assembling portions and an assembly space between the assembling portions, each assembling portion has a shaft hole and a securing hole, the assembly space configured for accepting the swinging end of the massaging member, the shaft holes of the two assembling portions and the through aperture of the swinging end both pivoted with the central shaft, and the securing holes of the two assembling portions respectively pivoted with a shaft bolt and the second end of the second link rod.

6. The massage device as claimed in claim 5, wherein a position of the securing hole of the assembling portion is higher than the shaft hole.

7. The massage device as claimed in claim 5, wherein a position of the securing hole of the assembling portion is lower than the shaft hole.

8. The massage device as claimed in claim 1, wherein the massaging end of the massaging member is driven by another motor to rotate the two massaging units.
